(19) United States
(12) Patent Application Publication
(10) Pub. No.: US 2016/0029798 A1
(43) Pub. Date: Feb. 4, 2016

(54) Pillow Stand for Tablet Computer

(71) Applicant: Jack Lo, Pacifica, CA (US)

(72) Inventor: Jack Lo, Pacifica, CA (US)

(21) Appl. No.: 14/499,199

(22) Filed: Sep. 28, 2014

Related U.S. Application Data
(63) Continuation-in-part of application No. 14/447,667, filed on Jul. 31, 2014, now abandoned.

(51) Int. Cl. A47B 97/00; G06F 1/16

(52) U.S. Cl. CPC A47B 97/00; G06F 1/1626; A47B 2097/006

(57) ABSTRACT

Tablet computers typically cannot stand up on their own. There are prior art padded stands for supporting tablet computers but they support the computers too low for reading, are too uncomfortable, or are oddly shaped. The present pillow stand includes an outer shell with flexible top and bottom panels connected by a planar seam to form an elongated olive-shaped cross section. A soft filler is enclosed within the outer shell. A receiving member is positioned on an exterior of the top panel for supporting a tablet computer in a standing position only along its lower end. A stabilizing member is positioned within the outer shell and connected to the receiving member through the top panel. The stabilizing member is engaged against the filler to support the receiving member and the computer. The stabilizing member spreads the weight of the computer across a large enough area of the soft filler to stably support the computer. The present pillow stand raises the tablet computer to reduce neck strain, it provides a soft hand rest in front of the computer, and it blends in with home decor by masquerading as an ordinary throw pillow.

### CROSS REFERENCE TO RELATED APPLICATION

This is a continuation-in-part of application Ser. No. 14/447,667 filed on 31 Jul. 2014, now abandoned.

### BACKGROUND OF THE INVENTION

1. Field of the Invention:

This invention relates to stands for tablet computers.

2. Prior Art:

A typical tablet computer, such the one trademarked iPad by Apple Inc., lacks any built-in structure for standing up on its own. Therefore it is often used by holding it in one hand, putting it flat on a desk, or putting it on the user's lap. These operating positions require the user to look down at the tablet, and prolonged use of the tablet in this posture may result in neck strain.

Many tabletop tablet stands are available for standing up a tablet on a desk or table. They support the tablet with its lower edge very close to the table. This low position still requires the user to look down and may cause neck strain. Tabletop tablet stands have narrow bases or feet that require a flat and stationary supporting surface. They are not practical for use on a user's lap.

At home, people often use tablets while sitting on a sofa or in bed. When the tablet is placed on a lap, it is usually held by one hand and operated by the other hand. The hand holding the tablet may get tired and the low position of the tablet may cause neck strain.

Padded stands specifically designed for supporting a tablet on a user's lap or bed are available. Some padded stands have a rigid horizontal top surface with a slot at a fixed angle for receiving a tablet. The hard surface conveniently serves as a lap table but is uncomfortable for supporting the hands and arms. Some padded stands have brackets for securing four corners of the tablet. Most prior art padded stands have a ledge or slot at a lower front edge for supporting the tablet, and a substantial portion of the height of the stand for supporting the back of the tablet. The tablet sits very low in front of the stand so neck strain may result. Most prior art stands have no support for the hands.

Although padded stands are sometimes referred to as “pillow stands”, they do not resemble or feel like pillows at all. They are either relatively rigid and/or oddly shaped, and they do not blend in with throw pillows on a sofa or bed pillows on a bed.

### BRIEF SUMMARY OF THE INVENTION

A pillow stand for a tablet computer includes an outer shell with flexible top and bottom panels connected by a planar seam. A soft filler is enclosed within the outer shell. The cross section of the pillow stand is an elongated olive shape. A receiving member is positioned on an exterior of the top panel for supporting a tablet computer only along its lower edge. A stabilizing member is positioned within the outer shell and connected to the receiving member through the top panel. The stabilizing member is engaged against the filler to support the receiving member and the computer. The stabilizing member spreads the weight of the computer across a large enough area of the soft filler to stably support the computer. In a first embodiment, the stabilizing member is a plate embedded within the filler. In another embodiment, the stabilizing member is a plate positioned between the top panel and the filler.

### BRIEF DESCRIPTION OF THE DRAWINGS

FIG. 1 is a side perspective view of the present pillow stand for a tablet computer.

FIG. 2 is a side perspective view thereof positioned upside down without the tablet computer.

FIG. 3 is an exploded view thereof.

FIG. 4 is a cutaway view thereof taken along line 4-4 in FIG. 1.

FIG. 5 is a side perspective view of another embodiment.

FIG. 6 is a top view of the embodiment of FIG. 5.

FIG. 7 is an assembly view of of yet another embodiment.

FIG. 8 is a sectional view of the embodiment of FIG. 7.

FIG. 9 is a sectional view of yet another embodiment.

FIG. 10 is a side perspective of yet another embodiment.

### DETAILED DESCRIPTION OF THE INVENTION

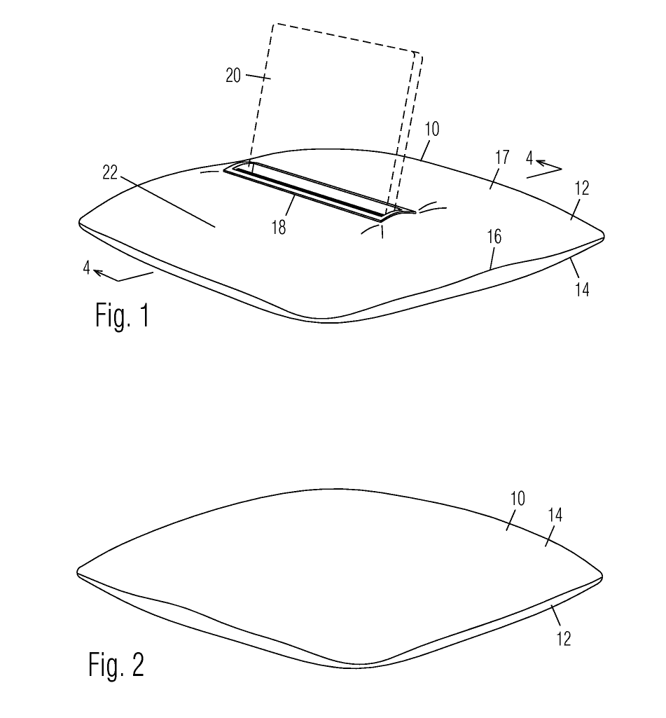

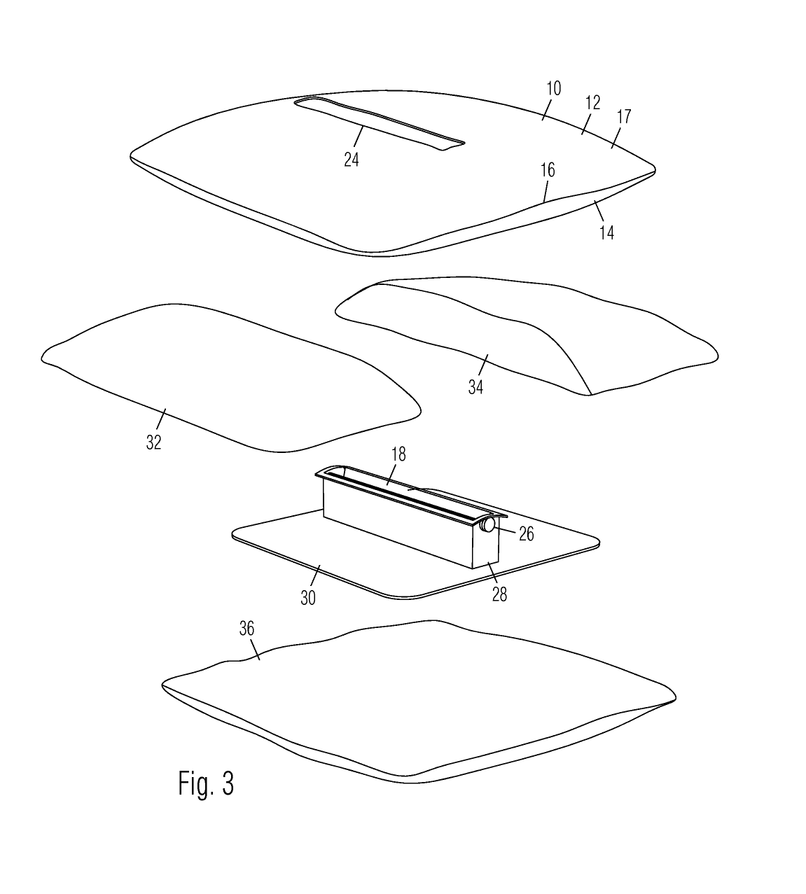

As shown in FIG. 1, a pillow stand 10 includes a flexible top panel 12 and a flexible bottom panel 14 connected by a generally planar seam 16 to form an outer shell 17. The top and bottom panels are preferably rectangular. A receiving member 18 is attached to top panel 12 at an intermediate position for receiving a tablet computer 20.

Pillow stand 10 is comfortable to place a user's lap. It is sized to span across both thighs so that it remains stable during minor movements. It supports the computer on it's very top to raise the computer closer to eye level to reduce neck strain. Since receiving member 18 is near the center of top panel 12, a forward portion of top panel 12 in front of receiving member 18 serves as a soft hand rest 22 for added comfort. It is in the shape of a common throw pillow so that it is aesthetically familiar and pleasing, unlike oddly shaped prior art padded stands. When not supporting a tablet computer, it may be turned over to present bottom panel 14 to masquerade as an ordinary throw pillow to completely blend in with home decor.

An exploded view of pillow stand 10 is shown in FIG. 3. There is a slit 24 near the center of top panel 12. Receiving member 18 is a transversely elongated slot connected by pivots 26 (one shown) to a connecting member 28 attached to a stabilizing member 30, which in this example is a horizontal plate. Soft fillers 32, 34 and 36 are positioned fully around connecting member 28 and plate 30.

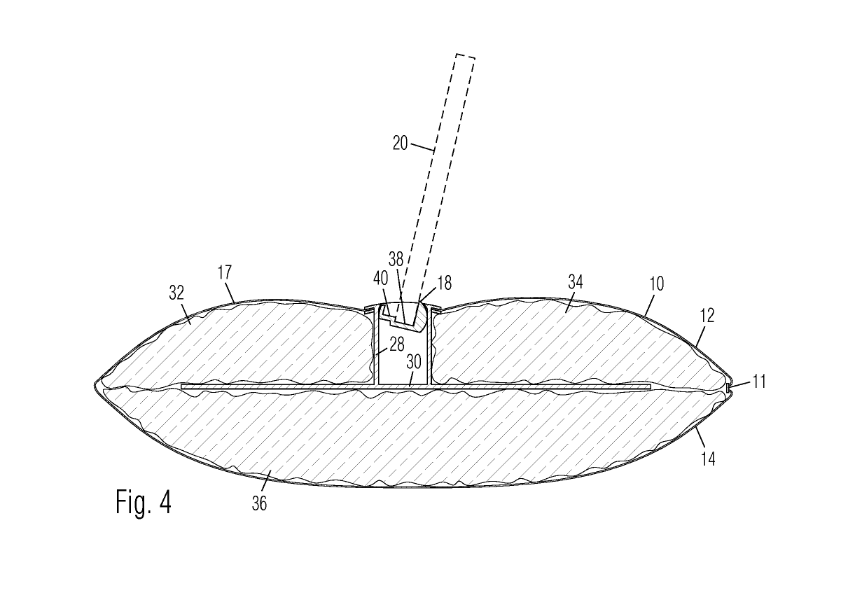

An assembled and sectional view of pillow stand 10 is shown in FIG. 4. Pillow stand 10 has an elongated, olive-shaped cross section. A closure 11, such as a zipper, is attached along an edge between top panel 12 and bottom panel 14. Stabilizing member 30 is fully enclosed within outer shell 17. Receiving member 18 is pivoted to connecting member 28 for adjusting the angle of tablet computer 20. The pivots include ratchets for holding a selected position. Receiving member 18 includes a narrow portion 38 for holding a bare tablet as shown, and a wide portion 40 for holding a tablet with a protective case (not shown) that adds to its thickness. Fillers 32, 34 and 36 are respectively positioned in front of connecting member 28, behind connecting member 28, and under stabilizing member 30. The fillers may be loose stuffing, such as fiber, enclosed by flexible inner shells, or they may be pre-formed pieces, such as open cell foam. Alternatively, the filler may be a contiguous mass of loose stuffing. Fillers 32, 34 and 36 completely surround connecting member 28 and stabilizing member 30. Therefore pillow stand 10 is soft and cushy to the touch substantially all around except at receiving member 18.

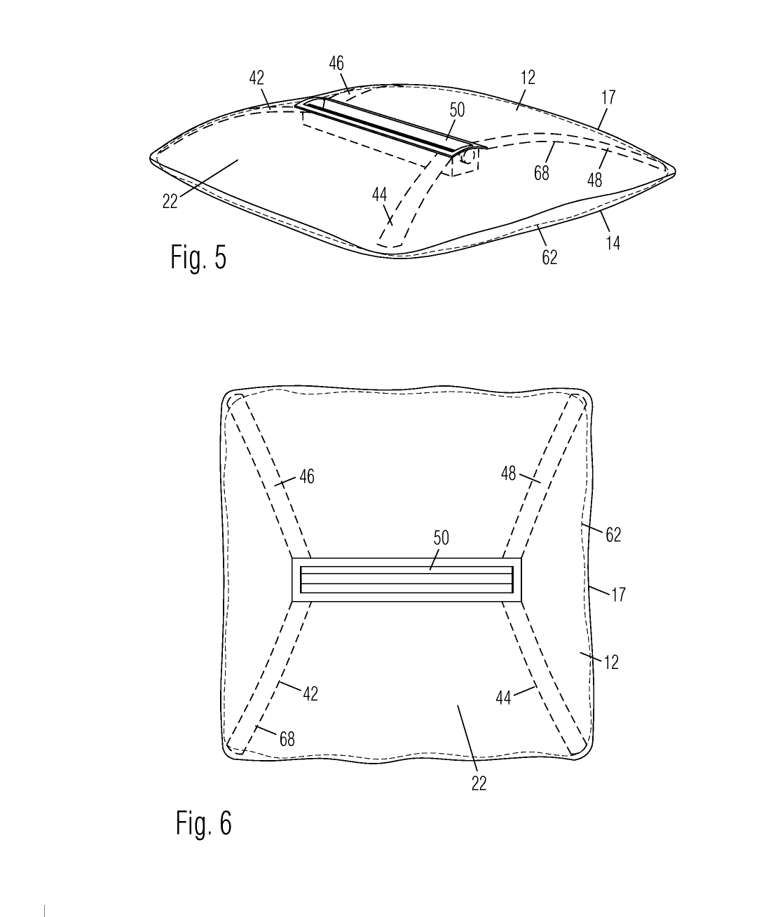

In another embodiment shown in FIGS. 5 and 6, a receiving member 50 for receiving a tablet computer has a stabilizing member 68 enclosed within outer shell 17. Stabilizing member 68 includes plates 42, 44, 46 and 48 that extend from receiving member 50 and positioned between outer shell 17 and a filler 62. The plates are engaged against the top of filler 62 to support receiving member 50 when it is holding a tablet computer. The forward braces 42 and 44 are separated by a wide gap to provide a soft hand support 22 in front of receiving member 50. Braces 42-48 are curved to follow the contour of top panel 12. The advantage of this embodiment is that a single filler is used within shell 17, wherein the filler includes loose stuffing enclosed by an inner shell.

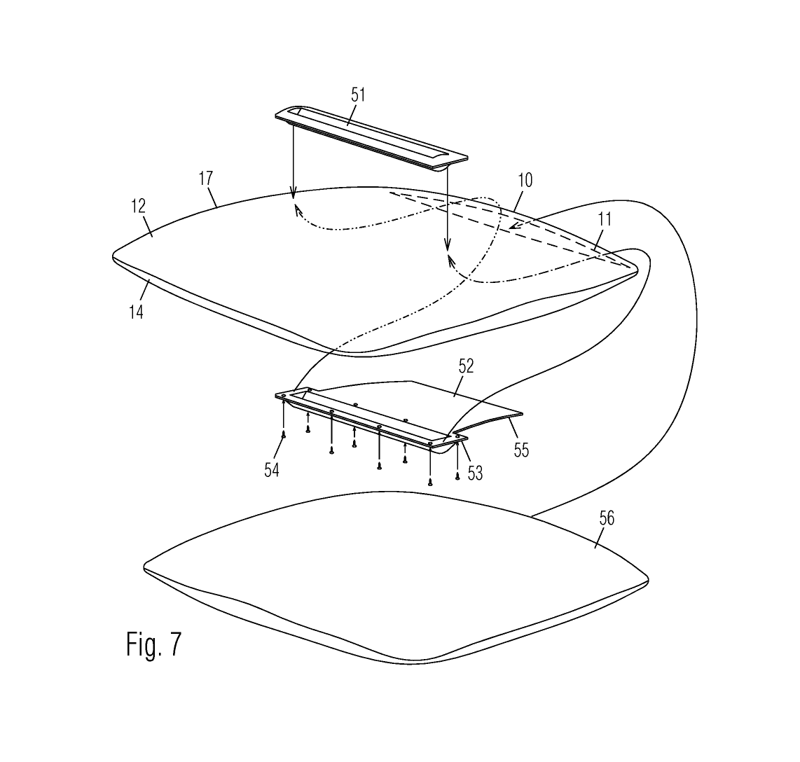

In yet another embodiment shown in the assembly view in FIG. 7, a receiving member 51 is placed against the exterior of top panel 12 of outer shell 17, as indicated by the arrows, for receiving a tablet computer. A stabilizing member 52 is inserted through closure 11 into outer shell 17 and placed against an interior of top panel 12. A proximal portion 53 of stabilizing member 52 is secured to receiving member 51 with fasteners 54 that pierce through top panel 12.

Fasteners 54 are shown as screws, but they may be latches or other types of fasteners. Stabilizing member 52 includes a distal portion 55 which projects away from receiving member 51. A soft filler 56 is inserted into outer shell 17 through closure 11, as indicated by the arrow. Stabilizing member 52 is positioned between top panel 12 and an exterior of filler 56. Stabilizing member 52 is plate shaped for distributing the weight of the tablet computer over a large enough area of soft filler 56 to prevent the tablet computer from tipping backwards.

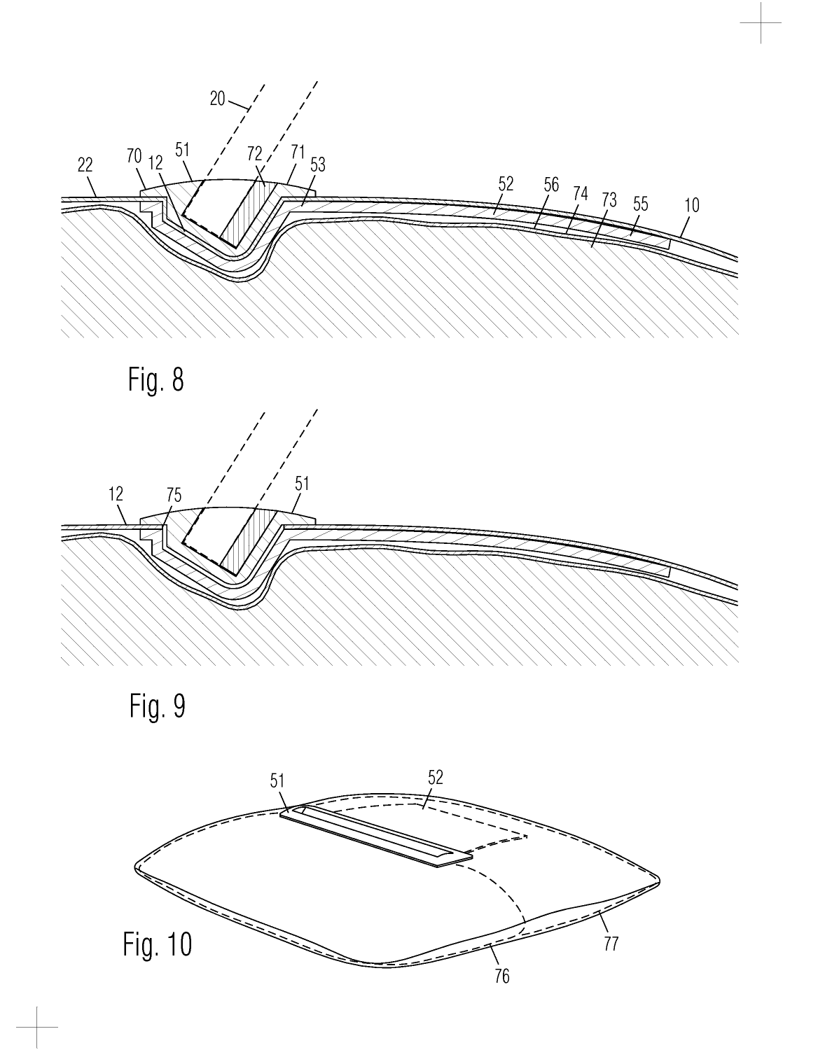

A sectional view of the embodiment of FIG. 7 is shown in FIG. 8. Top panel 12 has no cutout or slit and is simply clamped between receiving member 51 and stabilizing member 52. This simplifies production by avoiding the need to align receiving member 51 with a cutout in top panel 12. Fasteners such as screws easily pierce through top panel 12 to connect stabilizing member 52 to receiving member 51. Receiving member 51 has a front side 70 and a back side 71, and is tilted backwards for supporting tablet computer 20 at an angle for better viewing. A removable insert 72 is positioned in receiving member 51 for narrowing the space to receive a bare tablet, or it may be removed to receive a tablet with a protective case.

Since receiving member 51 is mounted on flexible top panel 12, the computer tends to rotate receiving member 51 backwards along its transverse or pitch axis. Stabilizing member 52 extends behind receiving member 51 and is positioned between top panel 12 and soft filler 56. When computer 20 is inserted in receiving member 51, the rotation of stabilizing member 52 caused by the computer is countered by stabilizing member 52 pressing on soft filler 56. Stabilizing member 52 is size to spread the force over a large enough area on soft filler 56 to minimize the backward tilting of the computer. Soft filler 56 includes loose stuffing 73 enclosed by an inner shell 74. The area in front of receiving member 51 is devoid of rigid structure to provide soft hand rest 22.

A sectional view of another alternative embodiment is shown in FIG. 9. It is the same as that of FIG. 8, except a slit 75 is provided in top panel 12 under receiving member 51 through which part of receiving member 51 projects through. Slit 75 reduces distortions and wrinkles in top panel 12.

FIG. 10 shows another embodiment the same as the embodiment of FIG. 8 or 9, except with a front filler 76 and a back filler 77 instead of a single filler. This helps to avoid the loose stuffing inside the fillers from being gradually pushed from the back to the front by stabilizing member 52.

Therefore the present pillow stand is most suitable for supporting a tablet computer on a user's lap while sitting on a sofa, chair or bed. It supports the tablet significantly higher than prior art padded stands to reduce neck strain. It is soft substantially all around to improve comfort. It provides a soft hand rest in front of the tablet. It closely resembles an ordinary throw pillow to blend in with home decor. When not supporting a tablet, it may be turned around to hide the slot so that it completely looks like an ordinary throw pillow.

1-10. (canceled)

11. A pillow stand for a tablet computer, comprising:
a shell comprising a flexible top panel connected to a flexible bottom panel along a horizontal seam;
loose stuffing inside the shell;
a receiving member on the top panel of the shell, wherein the receiving member comprises an upwardly directed slot for engaging a lower edge of the tablet computer, and the slot is angled backwards for supporting the tablet computer in a backwardly tilted freestanding position away from the top panel;
a stabilizing member inside the shell supported by the loose stuffing, wherein the stabilizing member has a front end connected to the receiving member through the top panel, and a rear end projecting backwards away from the receiving member for supporting the tablet computer which is tilted backwards and a center of gravity thereof is positioned above the stabilizing member; and
a soft hand rest comprising a front portion of the top panel between a front edge of the shell and the receiving member, wherein the hand rest is provided by terminating the front end of the stabilizing member at the receiving member, thereby generally avoiding having any part of the stabilizing member in front of the receiving member and keeping the front portion of the top panel soft for resting a user's hands in front of the tablet computer.

12. A pillow stand for a tablet computer, comprising:
an outer shell comprising a flexible top panel connected to a flexible bottom panel;
an inner shell inside the outer shell;
loose stuffing inside the inner shell inflating the inner shell and the outer shell;
a receiving member on the top panel of the outer shell, wherein the receiving member comprises an upwardly directed slot for engaging a lower edge of the tablet computer, and the slot is angled backwards for supporting the tablet computer in a backwardly tilted freestanding position away from the top panel; and
a stabilizing member positioned between the outer shell and the inner shell and connected to the receiving member through the top panel, wherein a rear end of the stabilizing member projects backwards away from the receiving member and engages the inner shell for supporting the tablet computer which is tilted backwards and a center of gravity thereof is positioned above the stabilizing member.

13. A pillow stand for a tablet computer, comprising:
an outer shell comprising a flexible top panel connected to a flexible bottom panel;
an inner shell inside the outer shell;
loose stuffing inside the inner shell inflating the inner shell and the outer shell;
a receiving member on the top panel of the outer shell, wherein the receiving member comprises an upwardly directed slot for engaging a lower edge of the tablet computer, and the slot is angled backwards for supporting the tablet computer in a backwardly tilted freestanding position away from the top panel;
a stabilizing member between the outer shell and the inner shell, wherein the stabilizing member has a front end connected to the receiving member through the top panel, and a rear end projecting backwards away from the receiving member for supporting the tablet computer which is tilted backwards and a center of gravity thereof is positioned above the stabilizing member; and
a soft hand rest comprising a front portion of the top panel between a front edge of the outer shell and the receiving member, wherein the hand rest is provided by terminating the front end of the stabilizing member at the receiving member, thereby generally avoiding having any part of the stabilizing member in front of the receiving member and keeping the front portion of the top panel soft for resting a user's hands in front of the tablet computer.
